(19) United States
(12) Patent Application Publication
(10) Pub. No.: US 2025/0080582 A1
(43) Pub. Date: Mar. 6, 2025

(54) CLOUD-BASED ADAPTIVE COMPUTING SECURITY

(71) Applicant: VMware LLC, Palo Alto, CA (US)

(72) Inventors: Tejas BUDUKH, Fremont, CA (US); Amit CHOPRA, Cedar Park, TX (US); Shipeng XIE, Millbrae, CA (US); Ranjani THIRUMALAI, Sunnyvale, CA (US)

(21) Appl. No.: 18/240,555

(22) Filed: Aug. 31, 2023

(51) Int. Cl. H04L 9/40; H04L 41/0604; H04L 41/16

(52) U.S. Cl. CPC H04L 63/20; H04L 41/0627; H04L 41/16

(57) ABSTRACT

The disclosure provides an approach for adaptive computing security. Embodiments include receiving, by a security rule adaptation system, alert information about a plurality of alerts generated based on one or more security rules. Embodiments include receiving, by the security rule adaptation system, user feedback with respect to a subset of the plurality of alerts. Embodiments include modifying, by the security rule adaptation system, a security rule based on the alert information and the user feedback to produce an adapted security rule. Embodiments include providing, by the security rule adaptation system, the adapted security rule to a security component, wherein the security component uses the adapted rule to detect computing security threats.

### BACKGROUND

As the number of threats to the security of computing environments continue to grow, cybersecurity solutions are assuming an increasingly important role in organizations. Many such solutions involve software products that analyze attributes and events in a computing environment in order to determine whether a threat may be present. Many such software products generate alerts when a potential threat is detected so that a security expert may view the alert and determine whether action needs to be taken in response to the potential threat.

The rapid growth of threats and corresponding cybersecurity rules and/or other techniques for threat detection has led to a situation in which organizations are often faced with the challenge of configuring a large number of security rules and handling a high volume of security alerts. Configuring large numbers of security rules is time-consuming and challenging, particularly due to the dynamic nature of threats to computing security. The large number of alerts may lead to “alert fatigue,” making it difficult for experts to determine which alerts warrant attention and action in order to protect the security of a computing environment. Furthermore, processing, displaying, and handling user feedback with respect to such a large number of alerts involves the utilization of large amounts of computing resources that may be unnecessary, particularly for alerts that are false positives, low priority, or otherwise do not warrant attention.

As such, there is a need in the art for techniques to improve the process of generating and managing security rules and to reduce the numbers of alerts provided to users of computing environments while avoiding security risks.

### SUMMARY

Embodiments provide a method of adaptive computing security. Embodiments include: receiving, by a security rule adaptation system, alert information about a plurality of alerts generated based on one or more security rules; receiving, by the security rule adaptation system, user feedback with respect to a subset of the plurality of alerts; modifying, by the security rule adaptation system, a security rule based on the alert information and the user feedback to produce an adapted security rule; and providing, by the security rule adaptation system, the adapted security rule to a security component, wherein the security component uses the adapted rule to detect computing security threats.

Further embodiments include a non-transitory computer-readable storage medium storing instructions that, when executed by a computer system, cause the computer system to perform the method set forth above, and a computer system programmed to carry out the method set forth above.

### BRIEF DESCRIPTION OF THE DRAWINGS

FIG. 1 is a block diagram depicting an example related to adaptive computing security.

FIG. 2 depicts an example user interface screen related to adaptive computing security.

FIG. 3 depicts another example user interface screen related to adaptive computing security.

FIG. 4 depicts a flow diagram of a method related to adaptive computing security.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for adaptive computing security. In certain embodiments, one or more security components may perform analysis of data related to one or more computing environments in order to detect potential security threats, and may generate alerts when such potential security threats are detected. For example, a cloud-based software application may analyze data received from a plurality of computing devices according to security rules in order to determine whether any security threats may be present, and may generate alerts when conditions specified in security rules are met by the received data. Alerts generated by such a security component may be provided to a user, such as a network administrator or other professional, so that the alerts can be reviewed in order to determine whether action should be taken to address a potential security threat.

Security rules that are applied by security components are conventionally generated through manual configuration, which can be a time-consuming, inefficient, and inexact process. Furthermore, in many cases a large number of alerts are generated based on such security rules, and it may be difficult for a user to review such a large volume of alerts in order to determine which alerts may warrant additional attention.

According to certain embodiments, a cloud-based computing security system provides dynamic security rule adaptation for security rules configured across a plurality of computing environments. In some embodiments, a rule adaptation service receives information about rules configured by users and also receives information about alerts generated based on such rules and user feedback with respect to such alerts. The rule adaptation service may also receive information about any such alerts that were suppressed by an alert suppression engine that suppresses alerts unlikely to require action. For example, an alert suppression engine may provide adaptive suppression of alerts through machine learning and/or rules, and may provide information about alerts that were suppressed to the rule adaptation service. The rule adaptation service may utilize the information it receives about rules, alerts, user feedback, and/or alert suppression to dynamically modify security rules for improved accuracy and optimized performance. For example, the rule adaptation service may adjust one or more parameters of a security rule based on the data it receives. In some embodiments, the rule adaptation service uses reinforcement learning techniques, such as assigning rewards or penalties to rule parameter values based on whether those parameter values are associated with certain outcomes indicated in the information about alerts, user feedback, and/or alert suppression. For instance, a rule parameter value that is associated with a certain number of alerts that were not suppressed and/or that were indicated in user feedback to be true positives may be rewarded according to the reinforcement learning algorithm. Conversely, a rule parameter value that is associated with a certain number of alerts that were suppressed and/or that were indicated in user feedback to be false positives may be penalized according to the reinforcement learning algorithm. The rule adaptation service may modify attributes of rules so as to maximize rewards and minimize penalties, resulting in “adapted” rules. Adapted rules may replace the original rules, either automatically or upon user confirmation (e.g., adapted rules may be recommended via a user interface for approval by the user).

It is noted that reinforcement learning is included as an example, and other techniques for determining when and how to modify parameters of security rules based on information about rules, alerts, user feedback, and/or alert suppression are possible. For example, in other embodiments supervised machine learning techniques may be utilized.

In some embodiments, the cloud-based security system may allow user to test a proposed security rule in a “silent” mode before deploying the proposed security rule in an active mode. For example, the proposed security rule may be applied to incoming data in order to determine whether to generate alerts, but any alerts generated based on the proposed security rule may be “silent” alerts that are not sent to a primary alerts view panel for review by the user and/or are otherwise not used to take action to prevent security threats. These silent alerts may be further sent to the alert suppression engine to determine whether the alerts should be suppressed. Furthermore, in some embodiments, the silent alerts are provided to the user (e.g., indicated as silent alerts) to review and provide feedback. The silent alerts, information about any of the silent alerts that are suppressed by the alert suppression information, and/or any user feedback with respect to the silent alerts may be gathered as metric data for use in determining whether to deploy the proposed security rule. For example, such metric information may be provided via a user interface along with user interface controls that allow the user to deploy, modify, or cancel the proposed security rule (e.g., based on the metric information). In certain embodiments, the system may recommend whether to deploy the proposed security rule and/or may recommend an adapted version of the proposed security rule (e.g., generated by the rule adaptation service), such as based on whether a certain number of silent alerts generated based on the proposed security rule were suppressed and/or were indicated by user feedback to be false positives.

Techniques described herein further involve analyzing proposed security rules that have been completely or partially configured by a user, determining whether there are any issues with such rules, and automatically recommending changes to the rules accordingly. For example, rules may be defined in a particular language that corresponds to a known schema, and systems described herein may parse a given rule according to the schema in order to determine whether there are any issues with the rule. For example, analyzing rules in this manner may allow for identification of logical errors in the rules, invalid parameter values, or other aspects of the rules that are likely to result in errors if the rules are evaluated. When such an error is detected, the user configuring the rule may be provided with a notification of the error and/or with a suggested change to address the issue (e.g., the suggestion may indicate a valid range for a parameter value).

Alerts generated based on rules that are configured and/or adapted as described herein may be displayed to users via user interfaces. For example, alerts that are not suppressed by an alert suppression engine may be displayed to a given user within an alerts console through which the user reviews alerts in order to determine whether to take action based on the alerts. Suppressed alerts may also be accessible by the user, such as via a different screen within a given user interface from the screen in which the non-suppressed alerts are displayed. In some embodiments, the alert suppression system suppresses a given alert by changing one or more attributes of the given alert, such as an open/closed status, a priority, a severity, or other attribute, and the user may be provided with user interface controls for filtering alerts by attributes. Thus, the user may be able to view subsets of both suppressed and unsuppressed alerts through user interface configuration changes. In some cases, adapting rules based on past suppression determinations as described herein allows rules to be dynamically adjusted so as to avoid generating alerts that would otherwise be suppressed.

Techniques described herein provide many technical benefits as compared to conventional computing security systems. For example, by utilizing information about alerts generated based on security rules, whether such alerts were suppressed by an alert suppression system, and/or user feedback with respect to such alerts to dynamically modify security rules, embodiments of the present disclosure produce improved security rules that reduce the number of false positive alerts that are generated, reduce the number of alerts that need to be proceed by an alert suppression engine, and thereby avoid the computing resource utilization that would otherwise be associated with processing, displaying, and handling user input with respect to alerts that are unlikely to require attention. Accordingly, embodiments of the present disclosure improve computing security by allowing high-priority alerts to be identified and addressed more efficiently. Furthermore, by allowing users to test proposed security rules in a silent mode prior to deploying such rules and by automatically parsing and detecting issues related to proposed security rules, techniques described herein allow security rules to be tested and optimized prior to deployment, thereby further improving efficiency, computing resource utilization, and computing security. Additionally, by performing computing security techniques described herein on a cloud-based platform, cross-device and cross-environment computing security services may be provided, such as making security determinations based on data from multiple devices and/or computing environments and allowing information from one device or computing environment to inform security determinations at another device or computing environment. As such, embodiments of the present disclosure provide computing security that is more holistically-informed, more dynamic, more efficient, and more accurate than conventional techniques.

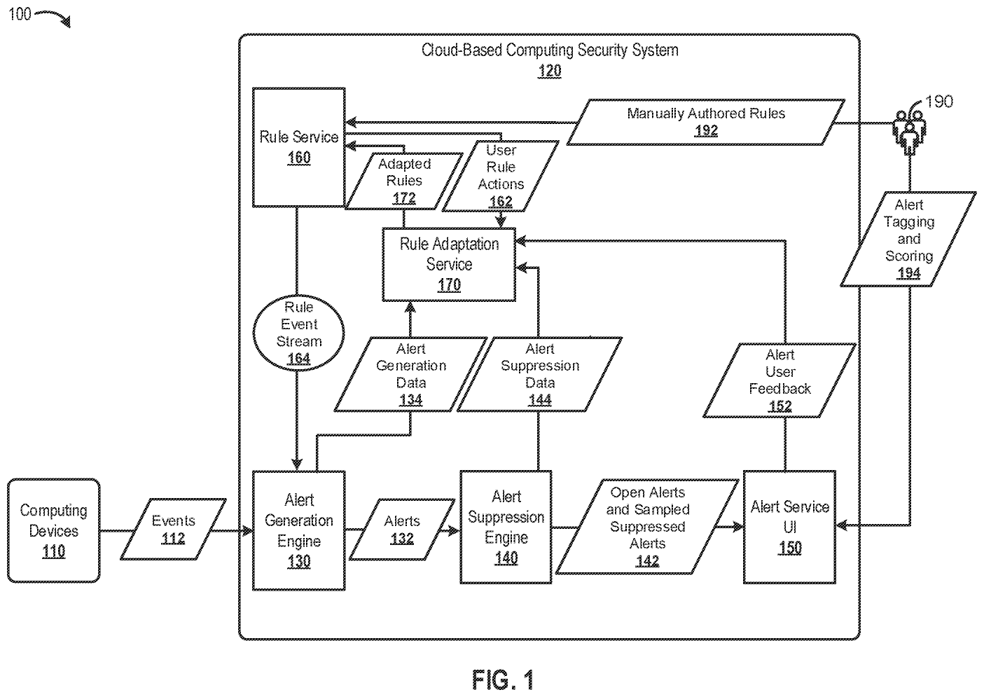

FIG. 1 is a block diagram 100 depicting an example related to adaptive computing security. Block diagram 100 includes a cloud-based computing security system 120, which generally performs operations described herein related to adaptive computing security.

Cloud-based computing security system 120 includes a rules service 160, which manages security rues that are applied by an alert generation engine 130 in order to determine whether to generate alerts.

For example, users 190 (e.g., associated with one or more computing environments) generate manually authored rules 192, which are provided to rule service 160. Manually authored rules 192 may be rules that indicate conditions under which a security threat may be present, and may have been configured by one or more users 190 by defining the rules in a particular language and/or via one or more user interfaces. In one example, a particular schema defines the language in which rules are authored, and cloud-based computing security system 120 parses rules according to that particular schema. Each of manually authored rules 192 may specify one or more parameter values.

Rule service 160 publishes user rule actions 162 to rule adaptation service 170. User rule actions 162 may include information about rules that are created, modified, and/or deleted, such as including the rules along with information relating to the creation, modification, or deletion of the rules (e.g., indicating the user(s) associated with the actions, the computing environment(s) and/or device(s) association with the actions, and/or the like, the days and/or times associated with the actions). As described in more detail below, rule adaptation service 170 uses various data points (e.g., via reinforcement learning or another type of automated logic) to dynamically adapt rules indicated in user rule actions 162 for improved accuracy and performance.

Rule service 160 provides rules to alert generation engine 130 via a rule event stream 164, which may include creations, modifications, and deletions of rules. Alert generation engine 130 evaluates the rules with respect to events 112 received from one or more computing devices 110, and generates alerts 132 when conditions specified in the rules are met by events 112. For example, computing devices 110 may include a plurality of computing devices across a plurality of different computing environments, such as corresponding to a plurality of different customers of an organization that provides cloud-based security system 120. A computing environment may, for example, refer to a network and/or collection of devices and/or processes associated with a particular organization, user(s), or other entity, such as a customer of a computing security services provider. In some embodiments, each of computing devices 110 includes a component (e.g., a “sensor” or “agent” of cloud-based computing system 120) that detects local events for that device and provides those events to alert generation engine 130 on cloud-based computing security system 120. Events 112 may represent information about various activities associated with computing devices 110 that are monitored by cloud-based security system 120, such as network connection events, network traffic, process events, file events, computing resource utilization events (e.g., when utilization of a particular computing resource exceeds a threshold, periodic indications of computing resource utilization, and/or the like) and/or the like. In some embodiments, by analyzing events across a plurality of computing devices 110, rather than only analyzing events on a single computing device, the cloud-based security system 120 is able to provide a more holistic view of potential security threats, such as identifying multi-device attacks that would not be evident based only on events from a single computing device. For example, a rule may indicate that if a certain number of packets are received on a particular port on two or more devices within a certain amount of time, then an alert should be generated.

Alerts 132 generated by alert generation engine 130 (e.g., when conditions specified in rules are met by events 112) may be provided to an alert suppression engine 140, which provides adaptive alert suppression services. Alert generation engine 130 also provides alert generation data 134 to rule adaptation service 170, which may use alert generation data 134 to dynamically adapt security rules, as described in more detail below. Alert generation data 134 may indicate which of alerts 132 were generated based on which rules.

In some embodiments, users may configure suppression rules, and these configurations may be received by alert suppression engine 140. An alert suppression rule generally specifies conditions under which an alert should be suppressed. In an example, an alert suppression rule specifies that alerts relating to network traffic received on a particular port should be suppressed (e.g., because the user has recognized that these alerts are not cause for concern and do not warrant attention). In some embodiments, an alert suppression rule specifies the mechanism by which alerts are to be suppressed under the rule, such as setting a severity or priority or severity of the alerts to a particular (e.g., low) value, setting a status of the alerts to inactive or closed, deleting the alerts altogether, and/or the like. Alert suppression engine 140 may also utilize a machine learning model that is trained to output indications of whether alerts should be suppressed based on input features related to the alerts.

Machine learning techniques generally involve using a set of training inputs and training outputs to build a model that will output a value in response to inputs. Inputs may be described as “features”. A training data set may be used to train a machine learning model. For example, each training data instance may include training data inputs or features (e.g., a signature, certain network events, file events, user information, process information, computing environment attributes, an assigned severity of the alert, and the like associated with an alert) associated with a training data output or label (e.g., an indication of whether or not the alert should have been suppressed based on user feedback). A plurality of training data instances is used to train the model, such as by constructing a model that represents relationships between features and output values. In some embodiments, training involves providing training data inputs to the model and iteratively adjusting parameters of the model until the outputs from the model in response to the training data inputs match (or fall within a certain range of) the training data outputs associated with the training data inputs, until a certain number of iterations have been completed without significant improvements in accuracy, or until some other condition or conditions are met. In some cases, training of a machine learning model is a supervised learning process, and may involve optimizing a cost function or loss function.

Features of an alert may be determined by identifying certain items of data associated with an alert. For example, features of an alert may include a port and/or network address associated with an action or actions that triggered the alert, files read, files written, a user identifier and/or other user attributes for a user associated with the action or actions that triggered the alert, application information of an application associated with the action or actions that triggered the alert, an operating system, version information (e.g., a patch version of an application), a protocol, network events such as callbacks when connections are made or terminated (e.g., for transport control protocol (TCP), user datagram protocol (UDP), or internet control message protocol (ICMP) connections), whether traffic is inbound or outbound, and/or the like), process events (e.g., process start and stop times, process traffic information, process identifiers), a severity assigned to the alert, a type and/or version of a computing device and/or network associated with the alert, and/or the like.

Labels may be based on user feedback with respect to alerts (e.g., received via a user interface), such as indicating that alerts should be suppressed for one or more reasons. For example, user feedback may indicate that an alert should have been assigned a lower severity or priority, that the alert is a false positive, and/or otherwise that the alert should not have been displayed to the user (e.g., that the alert should have been suppressed from a particular alert view or discarded altogether). A label may be in the form of a binary indication (e.g., indicating whether or not an alert should be suppressed), may indicate one of a set of possible classifications (e.g., false positive, true positive, lower severity/priority, higher severity/priority, a specific severity/priority, closed/inactive, open/active, and/or the like), and/or may otherwise indicate whether an alert should have been suppressed and/or a reason and/or mechanism by which an alert should have been suppressed.

The trained model may be subjected to testing. Testing generally involves providing data points from a test dataset as inputs to the model, receiving outputs, and verifying that the outputs match or fall within a given range of test labels. In some embodiments, a training data set generated based on user feedback (e.g., indicating whether given alerts should have been suppressed) is split into training data and test data for use in the separate training and testing stages.

The machine learning model may, for example, comprise a type of machine learning model known in the art, such as a neural network, a decision tree, a random forest, a long short term memory (LSTM) model, a gradient boosting machine, a linear regression model, or the like. Once the machine learning model is trained, features of an alert 132 generated by one of alert generation engine 130 are provided as inputs to the machine learning model, which outputs an indication of whether the alert 132 should be suppressed and/or a reason and/or mechanism by which the incoming alert 132 should be suppressed. Output from the model from the alert may be used to determine whether to suppress the alert, such as by changing one or more attributes of the alert (e.g., a status, a severity/priority, or other attribute) and/or discarding the alert altogether.

Once alerts 132 have been processed by alert suppression engine 140, such as using rules and/or a machine learning model to determine which alerts should be suppressed, alert suppression data 144 is provided to rule adaptation service 170. Alert suppression data 144 generally indicates which of alerts 132 were suppressed, the reason(s) for which alerts were suppressed (e.g., being false positives, low priority, and/or the like), and/or the like. As described in more detail below, rule adaptation service 170 may use alert suppression data 144 to dynamically adapt rules.

Alert suppression engine 140 provides alerts 142, which may include open alerts (e.g., alerts that have not been suppressed) and, in some embodiments, at least a subset of suppressed alerts, to an alert service user interface (UI) 150 for review by a user. For example, open alerts may be displayed in a primary alert view of alert service UI 150, while suppressed alerts may be displayed separately, such as in a separate screen or portion of the UI and indicated to be suppressed alerts. For example, a sampling of suppressed alerts may be selected for providing to the user in order to receive user feedback with respect to those suppressed alerts for use in improving the system through a feedback loop. The sampling may, for example, involve selecting a certain percentage of suppressed alerts, a certain number of suppressed alerts, a certain number or percentage of suppressed alerts of certain types, and/or the like.

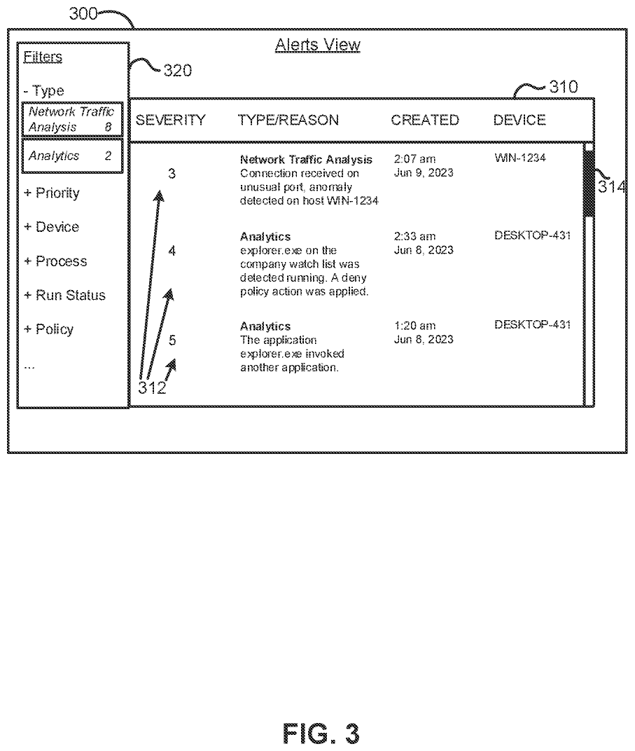

Users 190 may access alert service UI 150 in order to view alerts 142. An example of a user interface screen for viewing alerts is described below with respect to FIG. 3. Users 190 may provide feedback with respect to alerts 142 via alert service UI 150, such as providing alert tagging and scoring 194. Alert tagging and scoring 194 may involve tagging alerts as false positive or true positives, assigning scores to alerts (e.g., indicating severity or priority of the alerts), and/or the like. Alert service UI 150 provides alert user feedback 152 (e.g., based on alert tagging and scoring 194 by users 190) to rule adaptation service 170. This feedback loop allows cloud-based security system 120 to continually improve in a dynamic manner based on ongoing user feedback with respect to results of processing performed by alert generation engine 130, alert suppression engine 140, and rule adaptation service 170 such that subsequent results (e.g., subsequent rules, alerts, and suppression determinations) are more accurate, result in fewer false positives and more efficient review of alerts, further reduce computing resource utilization, and further improve computing security.

Rule adaptation service 170 uses user rule actions 162, alert generation data 134, alert suppression data 144, and alert user feedback 152 to dynamically adapt rules for improved accuracy and performance. For example, rule adaptation service 170 may analyze user rule actions 162, alert generation data 134, alert suppression data 144, and alert user feedback 152 in order to determine which rule parameter values or combinations of rule parameter values produce optimal or suboptimal results. An optimal result may, for example, involve the generation of alerts based on rules involving a particular rule parameter value that are primarily (or at least more than a threshold amount) indicated to be true positive alerts and/or high priority/severity alerts (e.g., based on the alerts not being suppressed and/or indicated in user feedback to be true positives and/or high priority/severity). A sub-optimal result may, for example, involve the generation of alerts based on rules involving a particular rule parameter value that are primarily (or at least more than a threshold amount) indicated to be false positive alerts and/or low priority/severity alerts (e.g., based on the alerts not being suppressed and/or indicated in user feedback to be false positives and/or low priority/severity). Rule adaptation service 170 may use this information to dynamically adapt rules, such as modifying parameter values of rules to be consistent with, identical to, or within a threshold range of parameter values determined to produce optimal results. Rule adaptation service 170 may adapt given rules based on alert generation data 134, alert suppression data 144, and/or alert user feedback 152 associated with those given rules (e.g., adapting rules based on their own results) and/or based on alert generation data 134, alert suppression data 144, and/or alert user feedback 152 associated with other rules (e.g., adapting rules based on results of other rules).

According to certain embodiments, rule adaptation service 170 utilizes one or more types of machine learning. In one example, rule adaptation service 170 uses reinforcement learning techniques in order to adapt rules. Reinforcement learning is a type of learning where the algorithm learns through trial and error, by receiving feedback in the form of rewards or penalties based on its actions. For example, certain parameter values for rules may result in rewards for the algorithm, while other parameter values may result in penalties for the algorithm. In some embodiments, a reinforcement learning algorithm rewards parameter values that are associated with optimal results (e.g., alerts that are all or mostly not suppressed and/or indicated in user feedback to be true positives and/or high priority/severity) and penalizes parameter values that are associated with suboptimal results (e.g., alerts that are all or mostly suppressed and/or indicated in user feedback to be false positives and/or low priority/severity). For example, a reinforcement learning model may be trained based on user rule actions 162, alert generation data 134, alert suppression data 144, and alert user feedback 152 to assign rewards to certain rule parameter values and penalties to other rule parameter values. Rule adaptation service 170 may use the trained reinforcement learning model to determine whether to make certain modifications to a given rule, such as to maximize rewards and minimize penalties.

Reinforcement learning is included as an example, and other types of machine learning and/or logic may be used by rule adaptation service 170 to determine rule parameter modifications. For example, a supervised learning model may be used in some embodiments. Supervised learning involves training an algorithm on labeled data, where the desired output is provided alongside the input. The algorithm learns to predict the output for new input data based on the patterns in the training data. Examples of supervised learning techniques are described above with respect to alert suppression engine 140. In one example, a machine learning model is trained through supervised learning techniques to accept input features of a rule (e.g., including rule parameter values) and output an indication of one or more recommended modifications to the rule. In other embodiments, unsupervised learning techniques may be used. Unsupervised learning involves training an algorithm on unlabeled data, where the algorithm learns to discover hidden patterns and structure in the data. Whether reinforcement learning, supervised learning, unsupervised learning techniques are used and/or whether other types of algorithms are used, rule adaptation service 170 may be more generally characterized as utilizing active learning to dynamically adapt rules based on new user rule actions 162, alert generation data 134, alert suppression data 144, and/or alert user feedback 152.

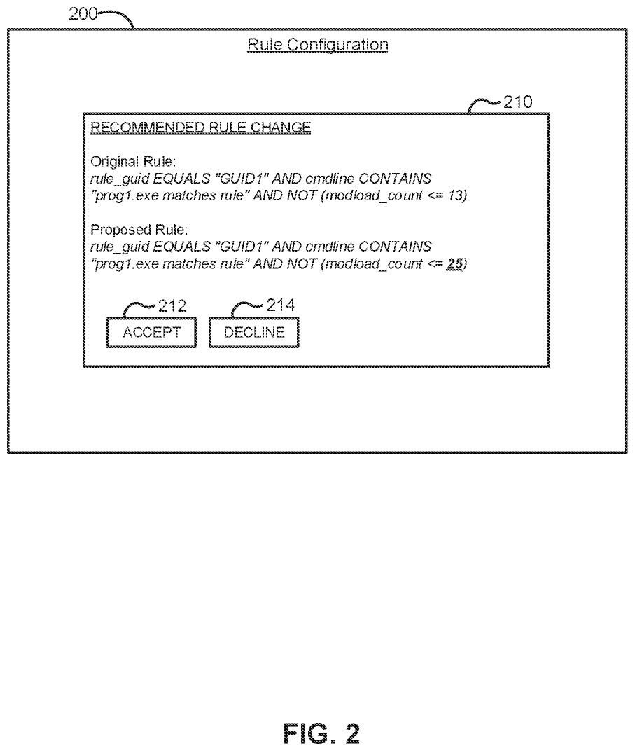

Rule adaptation service 170 generates adapted rules 172, such as by modifying rules (e.g., including manually authored rules 192) based on alert generation data 134, alert suppression data 144, and/or alert user feedback 152 (e.g., using machine learning and/or other types of logic). Adapted rules 172 generally comprise rules with parameters that have been modified to match or fall within a certain range of rule parameters that have been historically associated with optimal results. Adapted rules 172 are provided to rule service 160, which may replace prior versions of the rules with the adapted versions of the rules. In some embodiments, adapted rules 172 are presented for user approval via a user interface prior to being deployed (e.g., prior to replacing the prior versions of the rules with the adapted rules), as described in more detail below with respect to FIG. 2. In some embodiments, rule adaptation service 170 analyzes all rules on an ongoing basis as new user rule actions 162, alert generation data 134, alert suppression data 144, and/or alert user feedback 152 are received, such as generating an adapted rule 172 whenever it is determined that one or more parameters of a given rule are suboptimal and could be improved. In certain embodiments, rule adaptation service 170 analyzes rules as they are being defined by a user and/or immediately after they are defined by a user (e.g., before the rules are deployed) in order to determine whether adapted versions of the rules should be recommended to the user and/or otherwise deployed. For example, user rule actions 162 may include information about a rule that a user has just defined via a rule authoring user interface, and rule adaptation service may generate an adapted rule 172 for recommendation to the user based upon determining that one or more parameters of the rule have historically been associated with suboptimal results and could be improved through one or more modifications. If a user accepts or rejects a recommended adapted rule 172, that user feedback may also be provided to rule adaptation service 170 (e.g., as a user rule action 162) for use re-training one or more model(s) and/or algorithms to improve future rule adaptation.

In some cases, initial rule parameter values are set by domain experts and/or learned automatically from a prior distribution of data. For example, domain experts can specify an acceptable range for a given parameter value in order to avoid local minima, thereby maintaining accuracy of the system. In another example, the prior distribution of parameter values for particular parameters for a given domain (e.g., computing environment) may be analyzed in order to determine acceptable ranges for those particular parameters. These manually or automatically determined ranges may be used by rule adaptation service 170 as a starting point for its learning process by which it learns which parameter values produce optimal or suboptimal results.

Adapted rules 172 may be provided by rule service 160 to alert generation engine 130 via rule event stream 164 so that adapted rules 172 can be applied by alert generation engine 130 (e.g., instead of the prior versions of the rules). As alerts 132 are generated based on adapted rules 172, the associated alert generation data 134, alert suppression data 144, and/or alert user feedback data 152 for these alerts may be provided to rule adaptation service 170 for improving subsequent rule adaptations.

Furthermore, certain embodiments of the present disclosure involve parsing the language of rules that are defined by users (e.g., manually authored rules), when the rules are completely or even partially defined, according to a schema in order to determine whether there are any issues with the rules. For example, manually authored rules 192 may be defined in a particular language that corresponds to a schema known to cloud-based computing security system 120, and rule adaptation service 170 may use this schema to parse the language of rules. If rule adaptation service 170 detects an error with a rule based on such parsing, such as determining that an invalid parameter value is used or that there is a logical error with the rule (e.g., such that the condition(s) of the rule can never be satisfied or will always be true), rule adaptation service 170 may notify the user of this error. Rule adaptation service 170 may also recommend a change to the rule to resolve the error, such as a correction to a logical error or an indication of a valid range for a particular parameter.

In some embodiments, rules may be stateless or stateful. A stateless rule may be defined according to a schema using syntax such as: stringField stringComparisonOp QuotedString; EQUALS, =, EQUALS_IGNORE_CASE, CONTAINS, CONTAINS_IGNORE_CASE, MATCHES, STARTS_WITH, STARTS_WITH_IGNORE_CASE, ENDS_WITH, ENDS_WITH_IGNORE_CASE; numField numComparisonOp Number; =, <=, >=, <, >. Stateless rules may further be defined recursively, such as referencing other stateless rules in a manner such as: (statelessRule), NOT statelessRule, statelessRule AND statelessRule, statelessRule OR statelessRule.

For example, a stateless rule may be defined using the following syntax: rule_guid EQUALS “GUID1” AND cmdline CONTAINS “browser1.exe matches rule” AND NOT (modload_count<=13). This rule indicates that an alert should be generated if a rule global unique identifier (guid) is equal to GUID1, a command line contains the value “browser1.exe,” and a number of modloads is NOT less than or equal to 13.

A stateful rule may be defined according to a schema using syntax such as: RuleName: Stateless Rule Syntax; Rule1+Rule2*Rule3?; *—0 or more times; +—1 or more times; ?—0 or 1 times; {n}—exactly n times (n>0); {n,}—n or more times (n≥0); {n, m}—between n and m times (0≤n≤m, 0<m); {, m}—between 0 and m times (m>0); $ [n, m]—between n and m times with auto tuning. Sequential matching can be finished with any streaming system with memorized state ability.

For example, a stateful rule may be defined using the following syntax: statelessRule1+statelessRule2 {2,}. This rule indicates that an alert should be generated if conditions specified in a stateless rule named statelessRule1 are met and, also, conditions specified in a different stateless rule named statelessRule2 are met two or more times.

Conditions specified in rules may involve direct or explicit process relations, such as chaining of multiple processes (e.g., wevtutil cl application && wevtutil cl security && wevtutil cl setup && wevtutil cl system), processes performing multiple sequential actions (e.g., hh.exe process executing with .chm on command line and same hh.exe makes network connection to multiple devices), event counts (e.g., a particular IoA or “indicator of attack” happens 5 times), and/or the like. Conditions specified in rules may also involve indirect or implicit process relations, such as a dropped dynamic link library (DLL) file being loaded (e.g., foo.dll is dropped to disk and foo.dll is then invoked by rundll32.exe), a dropped file then being written to a registry key and referenced (e.g., a dropped file added to RunOnce or other runnable registry value), a web browser launching powershell (e.g., web browser executed and then powershell executed via cmd.exe/c powershell.exe, a macro, etc.), ransomware file encryption behavior (e.g., an executable is dropped and then a filemod is performed by the same executable), and/or the like.

In one example, a stateful rule involves a dropped DLL file being loaded. In particular, the stateful rule specified that an alert should be generated if foo.dll is dropped to disk by browser1.exe or browser2.exe (e.g., corresponding to particular applications) and then invoked by rundll32.exe. The stateful rule may be defined with reference to two stateless rules, as follows: statelessRule1: filemod_name EQUALS “foo.dll” AND (process_name EQUALS “browser1.exe” or process_name EQUALS “browser2.exe”); statelessRule2: process_name EQUALS “rundll32.exe” AND modload_name EQUALS “foo.dll”; statefulRule: statelessRule1+statelessRule2.

In another example, a stateful rule involves event counts. In particular, the stateful rule specifies that an alert should be generated if a web browser invokes powershell.exe a certain number of times. The count value may be modified by rule adaptation service 170, such as based on active learning as described herein, and may be, for example, at least 5: statelessRule1: child_procname CONTAINS “powershell.exe” AND parent_name MATCHES “(browser1|browser2|browser3)\.exe”; statefulRule: statelessRule1 $[5,]. For instance, the stateful rule may have initially been defined as a manually authored rule 192 to be statefulRule: statelessRule1 $[3,], and rule adaptation service 170 may have changed the rule to statefulRule: statelessRule1 $[5,] as an adapted rule 172.

In another example, a stateful rule involves network connections. In particular, the stateful rule specifies that an alert should be generated if an hh.exe process is executing with .chm on command line and then makes network connections to multiple devices. The stateful rule may be defined with reference to two stateless rules, as follows: statelessRule1: process_name EQUALS “hh.exe” AND cmdline CONTAINS “.chm”; statelessRule2: process_name EQUALS “hh.exe” AND netconn_inbound EQUALS “false” AND netconn_count>=2; statefulRule: statelessRule1+statelessRule2{2,}.

Rules may be adapted or “auto tuned” by rule adaptation service 170 as described herein through active learning based on alerts, alert suppression information, and user feedback. In certain examples, an alert confidence score is generated for each alert, and the alert confidence score is adjusted based on whether the alert is suppressed, whether the user provides positive or negative feedback with respect to the alert, and/or the like. If a rule parameter value is associated with a threshold number or percentage of low-confidence alerts (e.g., alerts that were generated based on one or more rules that include the rule parameter value and have confidence values below a threshold), then that rule parameter value may be determined to produce suboptimal results, and may be modified by rule adaptation service 170.

In some embodiments, cloud-based computing security system 120 allows a user to configure a proposed rule in a test mode, where the proposed rule is applied by alert generation engine 130 based on events 112, but any alerts 13 generated based on the proposed rule are silenced (e.g., not provided to the user via a primary alert view by which the user reviews open alerts). Such silent alerts may also be processed by alert suppression engine 140 to determine whether any of the alerts should be suppressed and, in some embodiments, some or all of the silent alerts may be provided to the user via a user interface (e.g., in a particular UI screen for reviewing silent alerts) in order to receive user feedback. The alert generation data 134, alert suppression data 144, and/or alert user feedback 152 associated with the silent alerts may be provided to rule adaptation service 170, and rule adaptation service 170 may provide such data to the user. For example, the user may be able to sort such metric information by device, device group, organization, rule type, and/or the like in order to review the results of applying the rules in silent mode.

Rule adaptation service 170 may also determine whether to generate and recommend an adapted rule 172 for the proposed rule based on such data. The user may review the metrics related to the proposed rule (e.g., the data provided by rule adaptation service 170) and determine whether to deploy the proposed rule (e.g., in an active or non-silent mode) based on the metrics. The user may also determine whether to accept or reject a recommended adapted rule to replace the proposed rule.

It is noted that while certain embodiments are described with respect to security components that generate security alerts based on security rules, techniques described herein may also be implemented for other types of rules and alerts, such as related to computing performance, resource utilization, likelihood of process and/or system failure, and/or the like.

FIG. 2 depicts an example user interface screen 200 related to adaptive computing security. For example, user interface screen 200 may be associated with cloud-based computing security system 120 of FIG. 1.

Screen 200 generally represents a rule configuration screen by which a user configures security rules. While not shown, screen 200 may include one or more UI controls and/or fields for defining rules in a syntax corresponding to a schema associated with cloud-based computing security system 120 of FIG. 1 and/or using a generic syntax or manner that is translated into the appropriate syntax by cloud-based computing security system 120 of FIG. 1.

A notification 210 indicates a recommended rule change. For example, a rule defined by a user may have been processed by rule adaptation service 170 of FIG. 1 as described above, and an adapted version of the rule may have been generated. Notification 210 recommends that the user change the rule from its original form (rule_guid EQUALS “GUID1” AND cmdline CONTAINS “prog1.exe matches rule” AND NOT (modload_count<=13)) to an adapted form (rule_guid EQUALS “GUID1” AND cmdline CONTAINS “prog1.exe matches rule” AND NOT (modload_count<=25)). For example, rule adaptation service 170 of FIG. 1 may have determined through active learning that the parameter value of 13 for the parameter modload_count in this context produced suboptimal results (e.g., a large number or percentage of suppressed, false positive, and/or low priority/severity alerts), while the parameter value of 25 for the parameter modload_count in this context produced optimal results (e.g., a large number or percentage of non-suppressed, true positive, and/or high priority/severity alerts).

Notification 210 is associated UI controls 212 and 214 that allow the user to accept or reject the proposed adapted rule. If the user selects UI control 212, the original rule may be replaced with the proposed adapted rule (e.g., the adapted rule may be deployed). If the user selects UI control 214, the proposed adapted rule may be discarded, and the original rule may be maintained (e.g., the original rule may be deployed if it has not yet been deployed, or otherwise may be left alone).

FIG. 3 depicts another example user interface screen 300 related to adaptive computing security. For example, user interface screen 300 may be associated with cloud-based computing security system 120 of FIG. 1. In an embodiment, screen 300 corresponds to alert service UI 150 of FIG. 1.

User interface screen 300 includes a panel 310 in which alerts (e.g., alerts 312, which may correspond to alerts 142 of FIG. 1) are displayed. For example, the alerts displayed in panel 310 may include “open” alerts that have not been suppressed by an alert suppression engine as described herein and, in some embodiments, sampled suppressed alerts. In the depicted example, certain attributes of each alert are displayed, including a severity of the alert (e.g., 3), a type and/or reason for the alert (e.g., “network traffic analysis,” “connection received on unusual port, anomaly detected on host WIN-1234”), a time stamp at which the alert was created (e.g., 2:07 am on Jun. 9, 2023), and a device for which the alert was generated (e.g., a device named “WIN-1234”). The alerts in panel 310 may sorted by severity, time stamp, and/or one or more other attributes (e.g., which may be configurable). In one example, panel 310 is a primary alerts view in which alerts meeting one or more conditions are displayed. Panel 310 includes a scroll bar 314 that allows the user to scroll up and down to view additional alerts that are not currently in view. Screen 300 further includes a customization menu 320 that allows the user to specify which alerts should be displayed in panel 310. For example, customization menu 320 allows the user to configure filters in order to limit which alerts are displayed, such as filtering by type (e.g., network traffic analysis alerts, analytics alerts, and/or the like), priority (e.g., which may be a direct property of alerts or may be configured in screen 300, such as specifying which severity ranges correspond to which priority levels, and/or the like), device, process (e.g., software application), run status (e.g., whether a process associated with the alert is running), policy (e.g., which policy or policies, such as rule or rules, triggered an alert), and/or the like.

Screen 300 may allow the user to review alerts and determine whether to take action based on the alerts, such as to prevent potential security threats. In some embodiments, a user may provide feedback via screen 300, such as indicating that an alert shown in panel 310 is a false positive or true positive or assigning a score (e.g., priority score or severity score) to an alert. For example, the user may select one of alerts 312, such as by clicking on the alert and/or by interacting with one or more user interface controls (not shown) for providing feedback, and may provide input indicating that the alert is a false positive or true positive, assigning a score to the alert, and/or the like. Such user feedback may correspond to alert tagging and scoring 194 of FIG. 1. The user may also access a different screen in order to view and configure alert suppression rules (e.g., screen 200 of FIG. 2), and recommended alert suppression rule changes may be presented to the user via such a screen (or via screen 300).

In some embodiments, selecting one of alerts 312 causes additional information about the selected alert to be displayed. In some cases, the user may determine that action needs to be taken based on an alert, such as disabling a connection, shutting down a process, restarting a process or device, and/or the like, and may take such action. Techniques described herein allow significant alerts to be identified and reviewed more efficiently within screen 300, such as by dynamically improving rules to avoid generating alerts that are unlikely to require action, thereby avoiding alert fatigue, improving security, and improving the functioning of the computing devices involved.

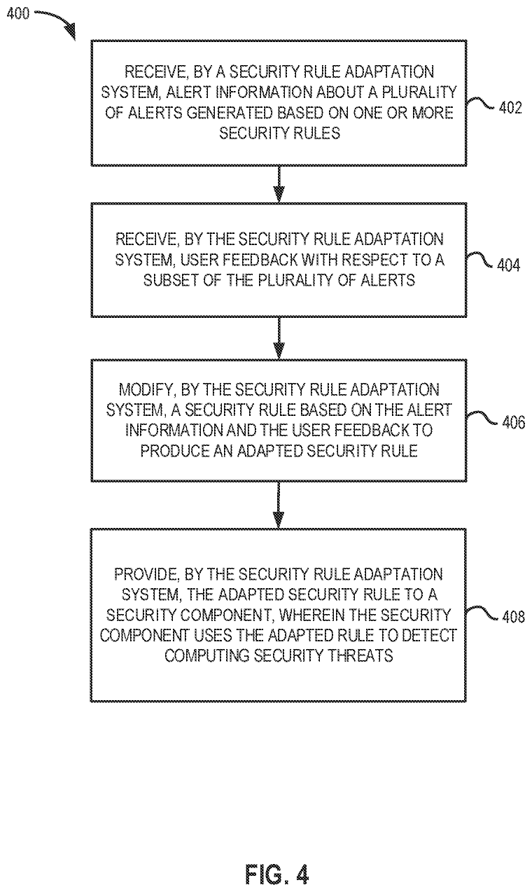

FIG. 4 depicts a flow diagram of a method 400 related to adaptive computing security according to embodiments of the present disclosure. In some embodiments, method 400 is performed by one or more components of cloud-based computing security system 120 of FIG. 1.

Method 400 begins at step 402, with receiving, by a security rule adaptation system, alert information about a plurality of alerts generated based on one or more security rules.

Method 400 continues at step 404, with receiving, by the security rule adaptation system, user feedback with respect to a subset of the plurality of alerts.

In some embodiments, the user feedback with respect to the subset of the plurality of alerts indicates whether a given alert in the subset of the plurality of alerts is a false positive. In certain embodiments, the user feedback with respect to the subset of the plurality of alerts indicates a score associated with a given alert in the subset of the plurality of alerts.

Method 400 continues at step 406, with modifying, by the security rule adaptation system, a security rule based on the alert information and the user feedback to produce an adapted security rule.

In some embodiments, the modifying, by the security rule adaptation system, of the security rule based on the alert information and the user feedback to produce the adapted security rule comprises changing a parameter of the security rule. In certain embodiments, the modifying, by the security rule adaptation system, of the security rule based on the alert information and the user feedback to produce the adapted security rule comprises utilizing a reinforcement learning algorithm.

Method 400 continues at step 408, with providing, by the security rule adaptation system, the adapted security rule to a security component, wherein the security component uses the adapted rule to detect computing security threats.

Some embodiments further comprise receiving, by the security rule adaptation system, from an alert suppression system, alert suppression information about one or more alerts that were generated based on the one or more security rules and that were suppressed, wherein the modifying of the security rule to produce the adapted security rule is further based on the alert suppression information.

Certain embodiments further comprise receiving, by the security rule adaptation system, user confirmation of the adapted rule before the providing of the adapted security rule to the security component.

Some embodiments further comprise receiving, by the security rule adaptation system, silent alert information about a plurality of silent alerts generated based on a proposed security rule and generating, by the security rule adaptation system, metric information about the proposed security rule based on the silent alert information.

Certain embodiments further comprise displaying the metric information about the proposed security rule via a user interface and receiving user input via the user interface in response to the displaying of the metric information, wherein the user input indicates whether to change the proposed security rule to an active security rule.

In some embodiments, the metric information is further based on silent alert suppression information about one or more silent alerts that were generated based on the proposed security rule and that were suppressed.

In certain embodiments, the security component generates an alert based on applying the adapted security rule to data received from a plurality of computing devices.

Some embodiments further comprise parsing a grammar of a given security rule based on a schema, determining a notification related to the given security rule based on the parsing, and providing the notification via a user interface. Some embodiments further comprise determining an error in the given security rule based on the parsing, wherein the notification indicates the error.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of adaptive computing security, comprising:
receiving, by a security rule adaptation system, alert information about a plurality of alerts generated based on one or more security rules;
receiving, by the security rule adaptation system, user feedback with respect to a subset of the plurality of alerts;
modifying, by the security rule adaptation system, a security rule based on the alert information and the user feedback to produce an adapted security rule; and
providing, by the security rule adaptation system, the adapted security rule to a security component, wherein the security component uses the adapted rule to detect computing security threats.

2. The method of claim 1, further comprising receiving, by the security rule adaptation system, from an alert suppression system, alert suppression information about one or more alerts that were generated based on the one or more security rules and that were suppressed, wherein the modifying of the security rule to produce the adapted security rule is further based on the alert suppression information.

3. The method of claim 1, wherein the user feedback with respect to the subset of the plurality of alerts indicates whether a given alert in the subset of the plurality of alerts is a false positive.

4. The method of claim 1, wherein the user feedback with respect to the subset of the plurality of alerts indicates a score associated with a given alert in the subset of the plurality of alerts.

5. The method of claim 1, further comprising receiving, by the security rule adaptation system, user confirmation of the adapted rule before the providing of the adapted security rule to the security component.

6. The method of claim 1, further comprising:
receiving, by the security rule adaptation system, silent alert information about a plurality of silent alerts generated based on a proposed security rule; and
generating, by the security rule adaptation system, metric information about the proposed security rule based on the silent alert information.

7. The method of claim 6, further comprising:
displaying the metric information about the proposed security rule via a user interface; and
receiving user input via the user interface in response to the displaying of the metric information, wherein the user input indicates whether to change the proposed security rule to an active security rule.

8. The method of claim 6, wherein the metric information is further based on silent alert suppression information about one or more silent alerts that were generated based on the proposed security rule and that were suppressed.

9. The method of claim 1, wherein the security component generates an alert based on applying the adapted security rule to data received from a plurality of computing devices.

10. The method of claim 1, wherein the modifying, by the security rule adaptation system, of the security rule based on the alert information and the user feedback to produce the adapted security rule comprises changing a parameter of the security rule.

11. The method of claim 1, wherein the modifying, by the security rule adaptation system, of the security rule based on the alert information and the user feedback to produce the adapted security rule comprises utilizing a reinforcement learning algorithm.

12. The method of claim 1, further comprising:
parsing a grammar of a given security rule based on a schema;
determining a notification related to the given security rule based on the parsing; and
providing the notification via a user interface.

13. The method of claim 12, further comprising determining an error in the given security rule based on the parsing, wherein the notification indicates the error.

14. A system for adaptive computing security, comprising:
at least one memory; and
at least one processor coupled to the at least one memory, the at least one processor and the at least one memory configured to:
receive, by a security rule adaptation system, alert information about a plurality of alerts generated based on one or more security rules;
receive, by the security rule adaptation system, user feedback with respect to a subset of the plurality of alerts;
modify, by the security rule adaptation system, a security rule based on the alert information and the user feedback to produce an adapted security rule; and
provide, by the security rule adaptation system, the adapted security rule to a security component, wherein the security component uses the adapted rule to detect computing security threats.

15. The system of claim 14, wherein the at least one processor and the at least one memory are further configured to receive, by the security rule adaptation system, from an alert suppression system, alert suppression information about one or more alerts that were generated based on the one or more security rules and that were suppressed, wherein the modifying of the security rule to produce the adapted security rule is further based on the alert suppression information.

16. The system of claim 14, wherein the user feedback with respect to the subset of the plurality of alerts indicates whether a given alert in the subset of the plurality of alerts is a false positive.

17. The system of claim 14, wherein the user feedback with respect to the subset of the plurality of alerts indicates a score associated with a given alert in the subset of the plurality of alerts.

18. The system of claim 14, wherein the at least one processor and the at least one memory are further configured to receive, by the security rule adaptation system, user confirmation of the adapted rule before the providing of the adapted security rule to the security component.

19. The system of claim 14, wherein the at least one processor and the at least one memory are further configured to:
receive, by the security rule adaptation system, silent alert information about a plurality of silent alerts generated based on a proposed security rule; and
generate, by the security rule adaptation system, metric information about the proposed security rule based on the silent alert information.

20. A non-transitory computer readable medium storing instructions that, when executed by one or more processors, cause the one or more processors to:
receive, by a security rule adaptation system, alert information about a plurality of alerts generated based on one or more security rules;
receive, by the security rule adaptation system, user feedback with respect to a subset of the plurality of alerts;
modify, by the security rule adaptation system, a security rule based on the alert information and the user feedback to produce an adapted security rule; and
provide, by the security rule adaptation system, the adapted security rule to a security component, wherein the security component uses the adapted rule to detect computing security threats.
